(19) United States
(12) Patent Application Publication
(10) Pub. No.: US 2011/0051233 A1
(43) Pub. Date: Mar. 3, 2011

(54) SCANNING CONFOCAL MICROSCOPY

(76) Inventor: David Woods, Buckinghamshire (GB)

(21) Appl. No.: 12/739,503

(22) PCT Filed: Oct. 27, 2008
(86) PCT No.: PCT/GB08/03638

§ 371 Date: Nov. 12, 2010

(30) Foreign Application Priority Data
Oct. 30, 2007 (GB) GB0721343.2

(51) Int. Cl. G02B 21/06

(52) U.S. Cl. 359/385

(57) ABSTRACT

Known scanning confocal microscope systems use an optical fibre to deliver light to the confocal scanning head. The illumination from the fibre may be uneven and significant light loss may occur in the fibre. According to the invention, an assembly is provided for inputting a light beam from a light source into the confocal scanning head of a scanning confocal microscope system, wherein the assembly comprises a beam width adjuster (6a, 6b), a beam director (8, 10) for controlling the path of the light beam, and a beam focussing means (12) for bringing the beam to a focus at a predetermined point at a light input of said confocal scanning head.

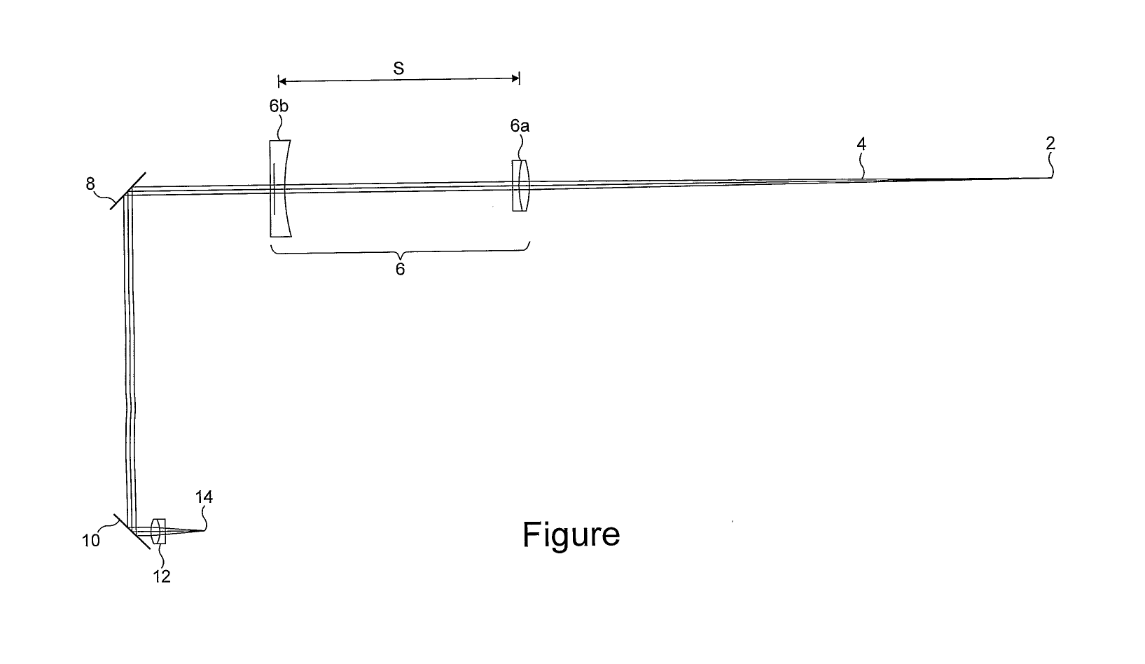

### FIELD OF THE INVENTION

The present invention relates to scanning confocal microscopy, and more particularly to the injection of light into the confocal head of a scanning confocal microscope system.

### BACKGROUND TO THE INVENTION

Confocal microscopes are used routinely for viewing internal details of semi-transparent microscopic bodies, especially in biological applications, often employing fluorescence illumination. The essential feature of such a microscope is the illumination of the sample by light focused through a pinhole, combined with observation of the returned light through the same pinhole, combined with observation of the returned light through the same pinhole, the result being that the detected light relates substantially to the specific image plane of the pinhole within the sample, rather than to planes above or below. This permits accurate depth resolution within the sample. Typically, a laser is used to provide a very tightly focused intense beam at the pinhole.

As described above, such a system gives information about only one point in the sample. However, the principle can be extended by two alternative and quite distinct approaches to give an extended image of the sample. In the first method, called ‘scanning spot’ the pinhole is scanned optically over the region of interest and the returned intensity is recorded in order to reconstruct an image of the sample. In the second method, many pinholes are illuminated in parallel to give simultaneous information across the region of interest. One such configuration is the “Nipkow disk” in which the pinholes are set into a disk which is then spun to give multiple scanned coverage of the region. This approach lends itself particularly well to the high speed imaging of live cells, a subject of considerable biological interest currently. Nevertheless, the present invention is relevant to all forms of confocal scanning.

Known scanning confocal microscope systems use an optical fibre to deliver the illuminating light from a light source to the confocal scanning head. Often, light from a number of different sources is optically coupled, either simultaneously or sequentially, into a single optical fibre which runs to the confocal head. Various methods are employed to couple light from multiple sources into a single, single-mode fibre, but these methods tends to be inefficient and involve difficult and elaborate alignments between various optical components.

Light emitted from single-mode fibres is Gaussian in nature. Thus, the illumination is concentrated around the axis of the fibre and its intensity drops in proportion to the angle away from the central axis. This gives rise to uneven illumination by the spot from a scanning spot system, or across the field of view of a multiple point scanning system.

Some confocal scanning heads (such as Yokogawa CSU X1) attempt to mitigate this by incorporating optics designed to redistribute illumination evenly across the field of view. However, optimum use of such optics demands high precision in the placement of the illumination entering the system. Adjustment of the position of the end of the input optical fibre to achieve this is difficult.

### SUMMARY OF THE INVENTION

The present invention provides an assembly for inputting a light beam from a light source into the confocal scanning head of a scanning confocal microscope system, wherein the assembly comprises a beam width adjuster, a beam director for controlling the path of the light beam, and a beam focussing means for bringing the beam to a focus at a predetermined point at a light input of said confocal scanning head.

Accordingly, the need for a fibre connection from the illumination system to the confocal head is eliminated. Accurate control of the illumination entering the confocal head is readily achievable with the claimed assembly, facilitating more efficient illumination and more even illumination relative to an optical fibre input. Furthermore, the light losses associated with use of an optical fibre are avoided.

Preferably, the beam width adjuster is arranged to collimate a diverging light beam. The adjuster may comprise a zoom lens arrangement, the beam width being adjustable by changing the spacing of optical elements of the zoom lens arrangement.

In a preferred embodiment, the beam director comprises two pivotably mounted mirrors, their pivotal axes being substantially mutually perpendicular to allow the direction of the light beam to be controlled in two orthogonal directions.

A light inputting assembly as described herein may be provided in combination with a confocal scanning head or as part of a scanning confocal microscope system.

A scanning confocal microscope system may be arranged to couple light from a plurality of sources into a common light path leading into the assembly. For example, the wavelength range associated with the light from each source may be different.

### DESCRIPTION OF THE DRAWINGS

A light input assembly embodying the invention will now be described by way of example and with reference to the FIGURE of the accompanying drawings.

A beam of light 4 emerges from an illumination system (not shown) at point 2. The beam may be emitted by a single light source. Alternatively, light from multiple light sources may be coupled in the illumination system onto the single path followed by the centre line of beam 4.

Beam 4 then passes through a zoom lens arrangement 6. This arrangement collimates light beam 4. The width of the collimated beam emerging from the zoom lens arrangement is adjustable by altering the spacing between two optical elements 6a, 6b which together form the zoom lens arrangement. It will be appreciated that various optical arrangements may be employed to provide a suitable zoom lens arrangement. In the embodiment illustrated, component 6a is in the form of a positive 75 mm diameter achromatic doublet lens, whilst component 6b is a negative 100 m diameter singlet lens.

The collimated beam emerging from the zoom lens arrangement is then incident on two mirrors 8 and 10 in turn. The mirrors are pivotably mounted, with their pivotal axes substantially mutually perpendicular to allow the direction of the light beam to be controlled in two orthogonal directions. This allows the beam direction to be controlled both spatially and in angle (4 degrees of freedom).

The beam is then brought to a point focus at point 14 by a focussing doublet lens 12.

By appropriate adjustment of the orientation of the mirrors and the configuration of the zoom lens, the launch of the light beam into a confocal head can be optimised to a fine degree.

The light injection approach described herein is more optically efficient than the use of an optical fibre. Typically, the transmission efficiency of a fibre may be in the range of 60% to 80%, whilst the efficiency achievable with the present assembly may be 90% or greater.

It will be appreciated that reference herein to a lens or optical element includes the use of multiple lenses in combination or a multi-component lens for the same purpose.

1. An assembly for inputting a light beam from a light source into the confocal scanning head of a scanning confocal microscope system, wherein the assembly comprises:
a beam width adjuster;
a beam director for controlling the path of the light beam; and
a beam focussing means for bringing the beam to a focus at a predetermined point at a light input of said confocal scanning head.

2. An assembly of claim 1 wherein the beam width adjuster is arranged to collimate a diverging light beam.

3. An assembly of claim 1 or claim 2 wherein the beam width adjuster comprises a zoom lens arrangement, the beam width being adjustable by changing the spacing of optical elements of the zoom lens arrangement.

4. An assembly of any preceding claim wherein the beam director comprises two pivotably mounted mirrors, their pivotal axes being substantially mutually perpendicular to allow the direction of the light beam to be controlled in two orthogonal directions.

5. A confocal scanning head in combination with an assembly of any preceding claim.

6. A scanning confocal microscope system including an assembly of any of claims 1 to 4.

7. A system of claim 6 including a plurality of light sources, wherein the system is arranged to couple a light beam from each light source into a common light path leading to the assembly.

8. A scanning head of claim 5 or system of claim 6 or claim 7 of the single point scanning type.

9. A scanning head of claim 5 or system of claim 6 or claim 7 of the multiple point scanning type.

10. A scanning head or system of claim 9 of the spinning disk type.
